(19) United States
(12) Patent Application Publication
(10) Pub. No.: US 2006/0212559 A1
(43) Pub. Date: Sep. 21, 2006

(54) Data source access editor and network data management method

(75) Inventors: Christopher James Martin Turnbull, Ottawa (CA); Jeffrey John Wissing, Ottawa (CA); Michael Slavitch, Ottawa (CA); Robert Turner, Ottawa (CA)

Correspondence Address: CONLEY ROSE, P.C., P. O. BOX 3267, HOUSTON, TX, 77253-3267, US

(73) Assignee: Objectworld Communications Corp., Kanata (CA)

(21) Appl. No.: 11/070,572

(22) Filed: Mar. 2, 2005

(51) Int. Cl. G06F 15/173

(52) U.S. Cl. 709/223

(57) ABSTRACT

A data source access editor and a network data management method are disclosed. The method is carried out in a network within which at least one data service element interacts with services. The network has data access layers, an administrator user interface and different platform data sources. The method includes the steps of: accepting administrator input through the user interface, processing the administrator input into executable instructions, and generating an abstraction of one of the platform data sources from the instructions. The abstraction defines a derivative of the one of the platform data sources that the data service element makes available to the services. The abstraction coordinates the data service element in effectuating operations on the one of the platform data sources, such that the operations generate data source responses communicated to the services in order for the services to be performed.

### FIELD OF THE INVENTION

The present invention relates to a network data management method and, in particular, to a method of providing services with defined access to data sources.

### BACKGROUND OF THE INVENTION

Computerized databases are collections of related information created, stored, or manipulated by a computerized management information system. A database schema is a description of a particular collection of data described by a given data model. Common database platforms have specific and unique methods for creating, modifying and accessing the structured data that they contain. Computerized databases are designed as machine to machine communications systems. The implication of this is that communications with databases are typically done by mechanisms designed by a domain expert that understands the underlying database particulars and structure, using software tools dependant on or specific to the domain.

Applications that access network data sources require software interfaces. The software interfaces can be written by a programmer or other domain expert in computer code using a specific syntax, either as a compiled software module or interpreted script using a specific programming language. Software written in text languages such as C, C++, Java, C# or CGI are then either compiled to become a module within a software system, or are interpreted by a software module that reads text.

In order to access data in such systems, specific domain knowledge is needed for the given database type including the following: authentication methods, methods for schema creation and modification, methods for searching for, locating and reading data, as well as methods for writing data into the system. There is thus a need to be able to exploit network databases in impressive ways without having to understand the details of the underlying databases, including how schemas are created and changed, how users are authenticated, or how fields are read from, written to, added to or removed.

### SUMMARY OF THE INVENTION

According to one example of the invention, there is provided a method of managing data in a network within which at least one data service element interacts with services. The network has data access layers, an administrator user interface and different platform data sources. The method includes the steps of:

(1) accepting administrator input through the user interface;

(2) processing the administrator input into executable instructions; and

(3) generating an abstraction of one of the platform data sources from the instructions, the abstraction defining a derivative of the one of the platform data sources. The data service element makes the derivative available to the services, and the abstraction coordinates the data service element in effectuating operations on the one of the platform data sources, such that the operations generate data source responses communicated to the services in order for the services to be performed.

According to another example of the invention, there is provided code employed in a network system. The system includes at least one data access layer between at least one network data source and a common data access layer. The common data access layer provides a data access interface between services and the data source. The code includes an editor application for creating an abstraction of the data source that coordinates at least one data service element in effectuating at least one operation on the data source. The data service element is adapted to give at least one of the services defined access to the data source. The data service element is also adapted to effectuate query-response communication between the services and the data source through the data access layer. The query-response communication results in the operation and a data source response being communicated to the services in order for the services to be performed.

### BRIEF DESCRIPTION OF THE DRAWINGS

These and other advantages of the invention will become apparent upon reading the following detailed description and upon referring to the drawings in which:—

FIG. 1 is a user interface window for entering administrator input in accordance with an embodiment of the invention;

FIG. 2 is a user interface window permitting a computer user to add fields to and delete fields from a derivative of an actual data source;

FIG. 3 is a user interface window in which a set of real estate listing entries are displayed;

FIG. 4 is a schematic diagram of an environment in which a system in accordance with an embodiment of the invention can be deployed;

FIG. 5 is a schematic diagram illustrating a data access architecture compatible with the environment of FIG. 4; and

FIG. 6 is a schematic diagram illustrating processing steps for a data source operation method in accordance with an embodiment of the invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings may have been given the same reference numeral or similar reference numerals.

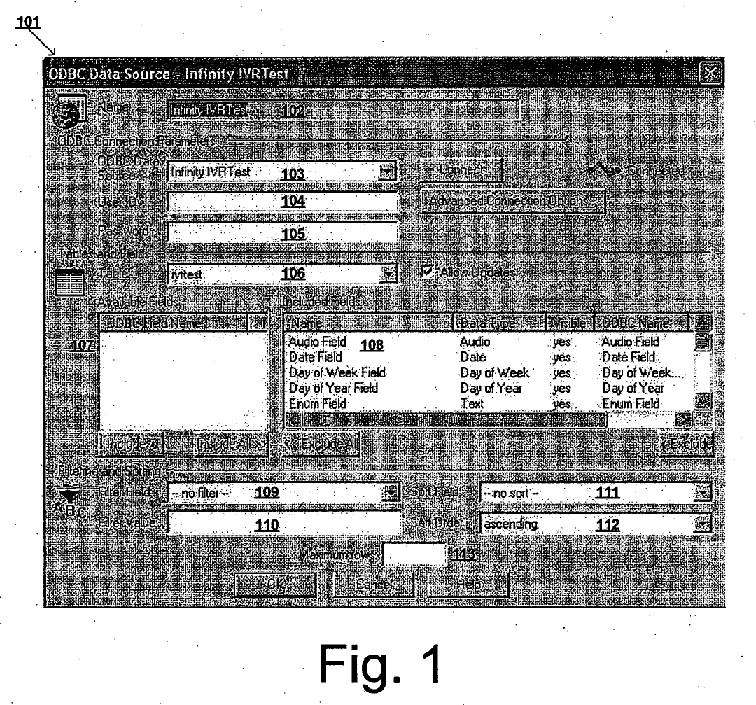

An administrative panel 101 is shown in FIG. 1. The panel 101 is a type of user interface window, and in particular a form-style window because it has a plurality of fields. Administrator input is accepted through the panel 101. As is subsequently explained, the administrative panel 101 is designed to permit an administrator to create an abstraction of an actual data source. In the illustrated example the administrator, naming the source InfinityIVRTest in text field 102, describes the ODBC data source or selects it using drop-down selector 103, and then connects to it with an ODBC appropriate User ID and password entered into text fields 104 and 105 respectively.

Once connected to the data source (in this case a database), the administrator can select a database table using drop-down selector 106 and select one or more available fields (of the table) displayed in available fields list 107. The one or more selected available fields can then be added to an included fields list 108. The administrator is thus able to select which fields will be included in a derivative of the actual database. If it is desired to have one or more fields removed from the included fields list 108, this can be done by selecting the appropriate fields displayed in the included fields list 108, and then clicking “Exclude”.

In the illustrated embodiment, a field filter configurer includes a drop-down selector 109 and a text field 110. First the administrator clicks on drop-down selector 109, and then selects the desired filter. A value can then be entered into text field 110 to provide a filter value for the filter selected using the drop-down selector 109. The resulting data can be sorted by field by selecting a particular sort using drop-down selector 111. Ascending or descending sort order can be chosen using drop-down selector 112. The maximum number of rows returned in a query is specified in text field 113.

The administrator panel 101 is a component in a data source access editor application that is usually installed at the terminal of the administrator. It will be understood that the administrative panel 101 is simply one example of possible user interface components designed to accept administrator input to carry out an embodiment of the method of the invention. Other possible user interface components need not be substantially similar to the panel 101. Also the form of the user interface component may vary depending upon the operating system on which the data source access editor application is running.

One skilled in the art will appreciate that the code for the data source access editor application can be stored on a variety of different computer readable media. Some examples (just to name a few) are CD, CD-R, DVD, hard disk medium and random access memory.

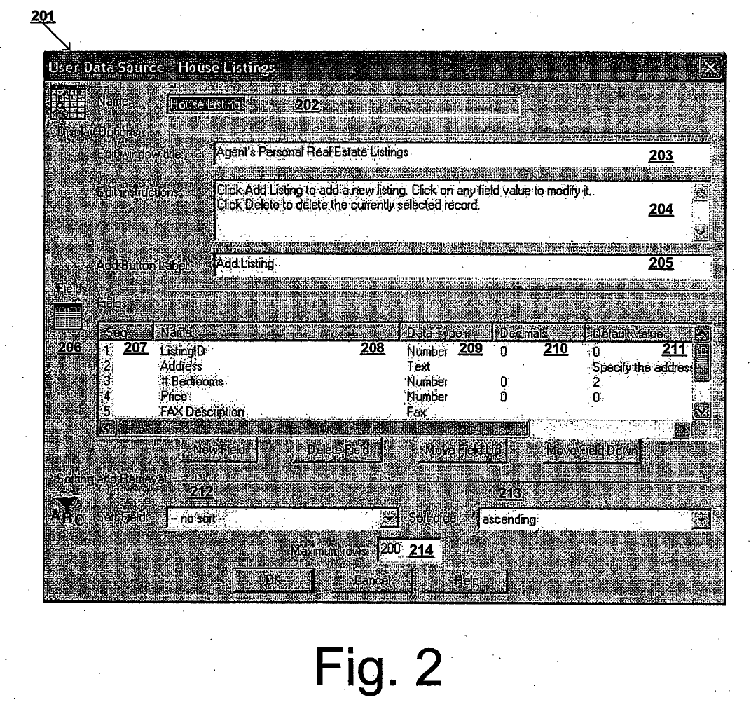

FIG. 2 illustrates a user interface window 201 permitting a computer user to add fields to and delete fields from the derivative of the actual data source. The user interface window 201 is similar to the administrative panel 101 illustrated in FIG. 1; but in the context of FIG. 2 the actual data source is abstracted. The computer user assigns a name to the table by entering it in the text field 202. For illustrative purposes only (not intended to limit the scope of the invention to this type of information) “Agent's Personal Real Estate Listings” is the string of text that has been entered in the text field 203 meaning the table contents has been assigned this as its name. Editing instructions have been inserted into the text field 204, and a data item entry title has been inserted into the text field 205.

The user creates one or more fields displayed in the fields list 206. These fields have the following: Sequence Number 207, Name 208, Data Type 209, Decimals 210 and Default Value 211. Similar to what was described in connection with FIG. 1, drop-down selector 212 permits the computer user to select a particular sort, ascending or descending sort order is selected using drop-down selector 213, and the maximum number of returned rows can be entered in text field 214.

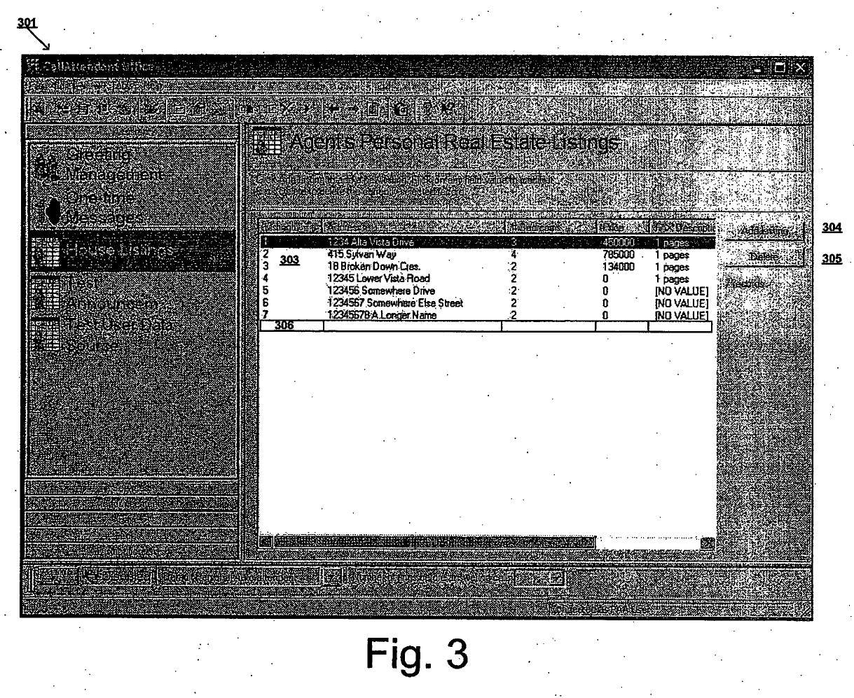

A user interface window 301 shown in FIG. 3 is designed to allow the computer user to manually enter data into the data table defined through the use of the user interface window 201 shown in FIG. 2. Continuing with data from the same illustrative example of the real estate context, the computer user clicks on “House Listings” in a menu 302 within a left frame of the window 301. This results in the data table being displayed in right frame 306 of the window 301. Individual entries in Real Estate Listings list 303 are either added by clicking on “Add Listing” 304 or deleted by clicking on “Delete” 305.

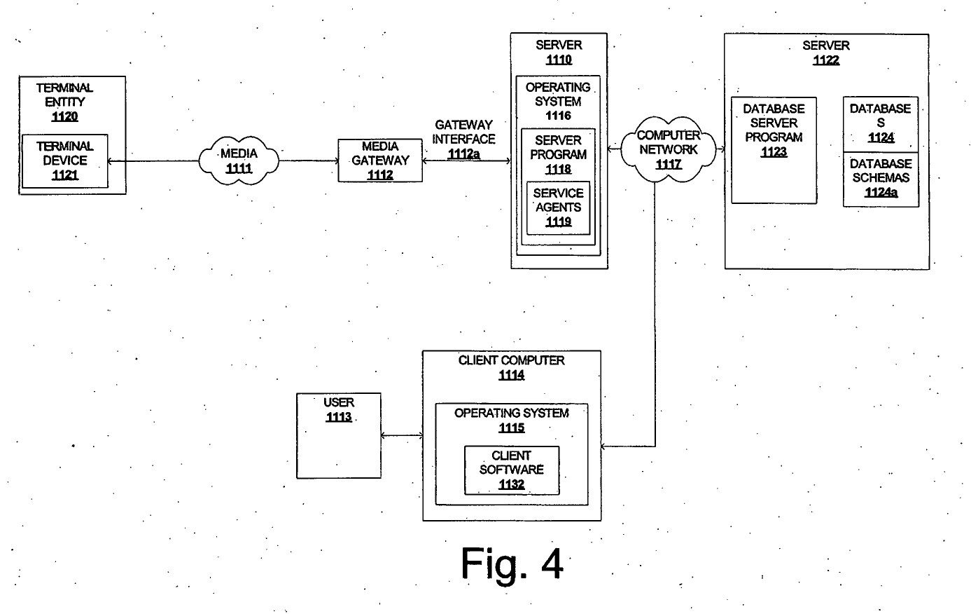

FIG. 4 is a schematic diagram of an environment in which a system in accordance with an alternative embodiment of the invention can be deployed. In this environment, one or more server computers 1110 are connected to any one of a variety of communications media 1111 via one or more media gateways 1112 and a gateway interface 1112a. The server 1110 is used by a plurality of users 1113 (for convenience only one user 1113 is illustrated) that have access to the system using their client computer or computer system 1114 that via an underlying operating system 1115, authenticates and connects to the server operating system 1116 via a computer network 1117. The network may be, for example, a TCP/IP (Transport Control Protocol/Internet Protocol) based intra-network consisting of LAN(s) (Local Area Networks) optionally interconnected by a WAN (Wide Area Network), and optionally connected to public inter-networks such as the internet with or without the use of VPNs (Virtual Private Networks). It will be understood that the client computer 1114 need not be a standard desktop machine. For example, the computer 1114 could be a handheld device.

The system disclosed in this patent document operates one or more server programs 1118 that can operate services or service agents 1119 (for convenience only one service agent 1119 is illustrated) that communicate with one or more terminal entities 1120, be they human or automated, that use one or more terminal devices 1121 that facilitate communications via supported communications media, data and/or signaling channels. The terminal devices 1121 may be telephones or computers with communications interfaces that may be voice driven, text driven, etc.

One skilled in the art will appreciate that for telephony the media can include wire-line, IP and wireless telephony defined by the International Telecommunications Union (such as CSS7, H.323, GPRS and others), methods defined by the Internet Engineering Task Force (such as SIP and others) and methods proprietary to specific vendors (be they Private Branch Exchanges or proprietary IP communications systems such as Skype). Also, two examples of non-audio media types are text-based messaging systems (for example, instant messaging) and web-based text interfaces, as defined by the World Wide Web Consortium.

The system disclosed in this patent document communicates with one or more database servers 1122 over the computer network 1117. The server 1122 contains a database program 1123 that operates on one or more databases 1124 described by one or more database schemas 1124a. The server program 1118 allows users 1113 to build the service agents 1119 that can access the databases 1124 using abstractions of the database schemas 1124a.

Users 1113 of the system 1110 can create service agents 1119 that that can communicate with terminal entities 1120. Users can create service agents using a client program 1132 such as the program described in a continuation-in-part patent application entitled GRAPHICAL INTERFACE BASED SOFTWARE FOR CREATING COMMUNICATION SERVICE AGENTS (hereinafter “the CIP application”) being concurrently filed on the same day, which application is incorporated by reference herein in its entirety.

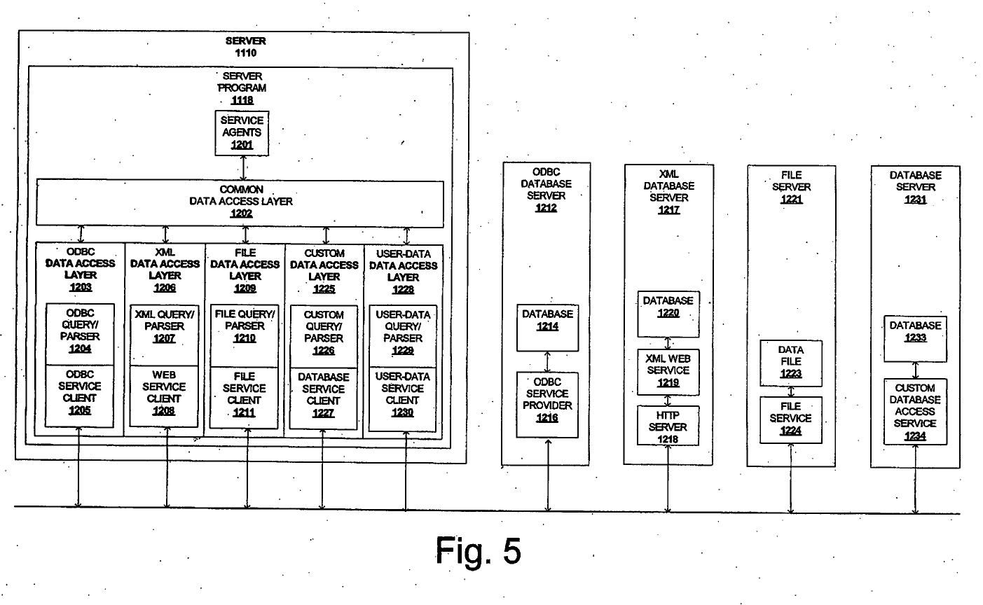

FIG. 5 illustrates additional details of the server 1110 and the database servers. A different platform data source is contained in each of the illustrated servers. With respect to the server 1110, a plurality of data access layers (DALs) and a Common Data Access Layer (CDAL) 1202 are illustrated in FIG. 5.

Service agents 1201 (for convenience only one service agent 1201 is illustrated) access the CDAL 1202. The CDAL provides a common interface for data access that is independent of the actual kind of data being used.

The server 1110 can contain DALs 1203, 1206, 1209 for data source types Open Database Connectivity (ODBC), Extensible Markup Language (XML) and file respectively. DAL is an initial abstraction of the data source, and in one embodiment is a software module written in a text language by a domain expert.

With respect to the ODBC DAL 1203, it contains an ODBC-based query mechanism and data parser 1204 that is linked by computer software program libraries to a corresponding ODBC driver 1205. The ODBC Driver 1205 can be provided by the vendor of an ODBC compliant database system. It will be understood that each ODBC driver is mated with a specific ODBC Query/Parser.

Communication with one or more databases 1214 that exist within the server 1212 is through an ODBC access service 1216. Different ODBC compliant database servers require different ODBC drivers. Due to deficiencies in the design of the ODBC specification, ODBC individual drivers may require different authentication credentials or offer different functionality. The abstracting of ODBC data sources with one or more DALs can alleviate this deficiency.

With respect to the XML Web Service DAL 1206, it contains an XML-based query mechanism and data parser 1207 that is linked via computer software program libraries to a web services client 1208 that conforms to the specifications of web service provider 1219. XML Web Services are accessed via a Hypertext Transfer Protocol (HTTP) compliant server 1218 that acts as a front end for the web service provider 1219. The web service itself acts as an access point to one or more database 1220.

Web Services is a collection of protocols and standards as defined by the World Wide Web Consortium. Protocols include the XML (Extensible Markup Language) protocol, Simple Object Access Protocol (SOAP) and a number of other protocols including SOAP Message Transmission Optimization Mechanism (MTOM) and others. Each protocol undergoes version changes which in turn support different functions. Individual XML Service Providers often support only one protocol version or are missing certain sub-components completely. The abstracting of XML data sources with one DAL for each specified XML Data Source can alleviate these deficiencies.

The server 1110 can contain one or more of the DALs 1209 for file data sources. The DAL 1209 contains a file query mechanism and data parser 1210 specific to the data source that is linked by computer software program libraries to a corresponding file service client 1211. Examples of file service clients include the Server Message Block (SMB) protocol supported by the Microsoft Windows™ family, the FTP protocol and the HTTP protocol for file transfers. At least one DAL exists for each supported file type.

The server 1110 can also contain one or more DALs 1225 for Custom Databases not supported by ODBC or XML. The DAL 1225 contains a file query mechanism and data parser 1226 specific to the custom database that is linked by computer software program libraries to a corresponding database service client 1227. Examples of custom databases include Object-Oriented databases such as Microsoft Active Directory and the Lightweight Directory Access Protocol. At least one DAL exists for each supported custom database.

The server 1110 can also contain one or more User-Data DALs 1228 for User-Defined Data Tables. The DAL contains a query mechanism and data parser 1229 for either ODBC, XML, File or Custom Database Data Sources that is linked by computer software program libraries to a service client 1230.

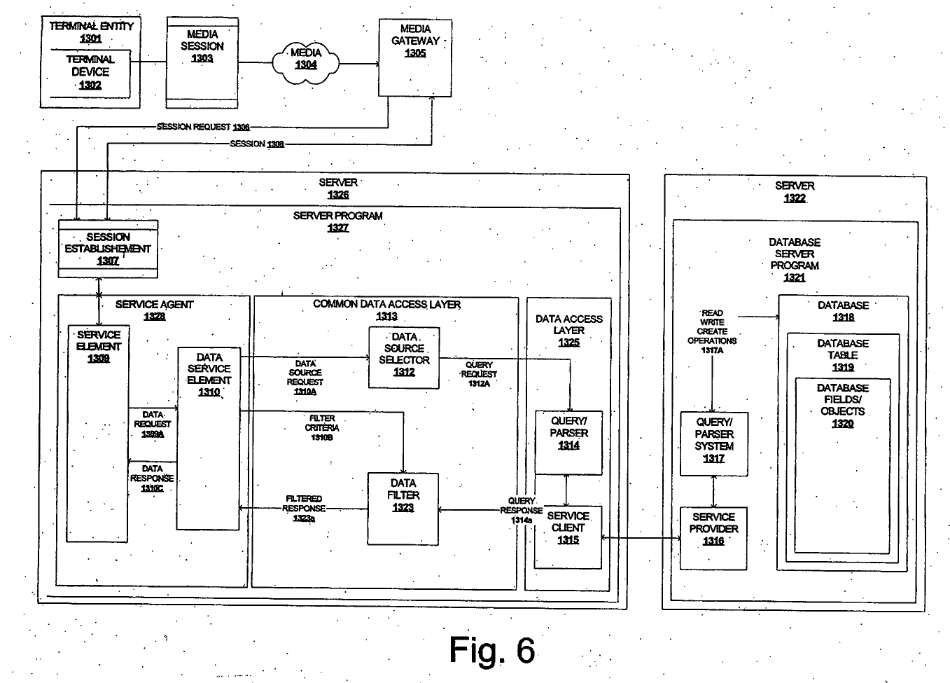

FIG. 6 is a schematic diagram illustrating processing steps for a data source operation method, the processing steps including requests and responses through a CDAL 1313 and a DAL 1325. In FIG. 6, a terminal entity 1301 using a terminal device 1302 requests a media session 1303 over the prescribed media 1304 for that terminal. A gateway 1305 for that media type initiates a session request 1306. A session 1308 is established 1307 with a corresponding service agent 1328 for the session request 1306 and a session is established between the terminal entity 1301 and the service agent 1328.

The service agent 1328 contains one or more service elements 1309 which can communicate a data request 1309a to a data service element 1310.

Service elements (such as the service element 1309) are computer objects that contain attributes and methods specific to a certain operation, function, or purpose, and they are the object classes from which services are derived. Service elements can be input/output communication path components, data sourcing components, operators on data items or communications paths, and/or actions. While service elements can be object-based representations of generic computer system or communication media functions, service elements can also inherit and contain within themselves, services based on other service elements.

A service (such as the service agent or service 1328) is a set of service elements that are invoked in a given sequence or pattern given a stimulus. The stimulus can be, but is not limited to: the creation of a media/data/signaling channel, information received via a media/data/signaling channel, queries from an entity using a media/data/signaling channel, data values returned from an external source via a media/data/signaling channel, or time stimulus generated locally or remotely via a media/data/signaling channel. The manner in which a service is invoked depends on the stimuli associated with the media, data and signaling channels.

Service agents and service elements are described in more detail in the CIP application.

The data service element 1310 is a special type of service element. Also, the data service element 1310 is an object that obtains and operates upon data that can be acted upon in a common representative form by the CDAL 1313. In one embodiment, data service elements are the common source for external data for all services defined by users of the system, and they give the services defined access to actual data sources. With respect to this defined access, an administrator created definition (that at least in part characterizes the defined access) can include database specifics such as database schema, table and field information, as well as authentication and security information.

The data source access editor application that has been described can be used to set access rights to a data source (such as database 1318) for computer users using the network. An administrator can disable access to the database 1318, make the database 1318 accessed only by the administrator, or can grant access to one or more computer users or groups of computer users using the network. Access attributes can include rights to read data items from the database 1318, modify data items in the database 1318, add new data items to the database 1318, and delete items from the database 1318, or any combination thereof. If the database 1318 is such that it can be read but not modified, the database 1318 can be tagged read-only for all computer users.

Based on this rights hierarchy, the data offered by the database 1318 can be global to the network, global but limited to selected computer users, or global but limited to individual users. The term global database (or global data source) refers to any of these three, meaning that all computer users that use the database 1318 are operating on a common instance of data. For data sources where the data is common to all authorized computer users and groups, read and write access to the data source will be permitted in a manner such that access rights to the individual records will map to the access rights for the data source itself. If the database 1318 (or other data source) so supports it, the data source editor application can create data within the database 1318 that is local to individual computer users or groups. The created data source or data sources are called local data sources, which while being likewise identical in terms of source, authentication techniques, and rights are individual instances local to single computer users or groups. The difference between global data sources and local data sources is that in the former case, if a computer user or group is created or modified to have access to the global data source, it has access to the common instance. In the latter case, if a computer user or group is created or modified to have access to a local data source, a new instance of the data source is created unless an existing instance is specified when the change is made.

The administrator has the capability of using the existing rights scheme offered by the system. Alternatively, if the system is so configured, the administrator can create a different rights mapping based on a criteria specific to the installation.

Administratively defined data sources can have data retrieved from them by data service elements, such as the data service element 1310. Also, data service elements can modify these data sources (add, change and delete) and can select from sets of values within such data sources. It will be understood that the data service element object has attributes that depend on the data source.

In the example diagram of FIG. 6, the data service element 1310 requests data from the CDAL 1313 using as a data source one of the offered data sources that is made available by a data source selector component 1312. The data source selector component 1312 communicates a query request 1312a to the appropriate DAL 1325. The query request 1312a is one that can be understood by that data access layer. A query/parser mechanism 1314 then translates the request into a manner understood by a service client 1315 which then forwards the query to a database service provider 1316 that uses a query/parser mechanism 1317 of the database 1318 to perform operations 1317a, either reading, setting or creating appropriate database fields or objects 1320 in an appropriate table 1319 in the correct database 1318. The database system query/parser mechanism 1317 returns results of the request via the service provider interface 1316 to the service client 1315 in the DAL 1325. The DAL Query/Parser mechanism 1314 translates this response into a response 1314a readable by a data filter 1323 in the CDAL 1313. The data filter 1323 reduces the response data to a set that meets the criteria in the data request 1309a if the data has not been previously filtered to these criteria by originating database server 1322 in its query/parser mechanism 1317.

In one embodiment, the data filter 1323 abstracts the data filtering mechanisms commonly seen in relational databases such that equivalent common filtering is performed for all data sources whether they support filtering mechanisms or not. The filtered response 1323a is returned to the data service element 1310 in a manner that is consistent for all data sources.

With particular reference to FIGS. 1 and 6, a method of managing data in a network has been described. In a first step of the method, administrator input is accepted through the administrative panel or administrator user interface 101. In the second step of the method, the administrator input is processed by a data source access editor application such as the one that has been described. Executable instructions are the product of this processing. In a third step of the method, an abstraction of one of the different platform data sources of the network is generated from the executable instructions. The abstraction defines a derivative of this data source, and the data service element 1310 makes it available to services, such as the service or service agent 1328. The abstraction coordinates the data service element 1310 in effectuating operations on the one of the data sources (for example the database 1318), and the operations generate data source responses (such as the data response 1310c) communicated to the service 1328 (or alternatively to other services) in order for the service 1328 to be performed.

Thus, the data service element 1310 can effectuate operations on a data source. These operations include:

1. Retrieving data objects from within the data source.

2. Updating or modifying data objects that exist within the data source, including:
i) Specifying values for value-based attributes (fields) within a relational database record.
ii) Transferring data to data-based attributes (field) within a relational database object.
iii) Creating, adding to or modifying an object in an object-oriented database object.
iv) Deletion of the object or record itself.

3. Retrieving, modifying or deleting a group of objects based on queries that return filtered responses. Queries can be based on, but not be limited to:
i) Field name and value, for relational databases.
ii) Object name and type, for object-oriented databases.

The combination of unanimous data source abstraction, unanimous data access abstraction and unanimous filtering allows any data source that can be supported by a DAL to be accessed in a way that might not otherwise be possible.

Thus, it is apparent that there has been provided in accordance with the invention a data source access editor and network data management method that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingy, it is intended to embrace all such alternatives, modifications and variations as fall within the spirit and broad scope of the invention.

What we claim as our invention:

1. A method of managing data in a network within which at least one data service element interacts with services, the network having data access layers, an administrator user interface and different platform data sources, the method comprising the steps of:
accepting administrator input through said user interface;
processing said administrator input into executable instructions; and
generating an abstraction of one of said platform data sources from said instructions, said abstraction defining a derivative of said one of the platform data sources that said data service element makes available to said services, and said abstraction coordinates said data service element in effectuating operations on said one of the platform data sources, such that said operations generate data source responses communicated to said services in order for said services to be performed.

2. A method of managing data in a network according to claim 1 further comprising the step of generating a form-style window of said user interface before the accepting step, said form-style window including fields for displaying said administrator input.

3. A method of managing data in a network according to claim 2 wherein said form-style window further includes a field filter configurer.

4. A method of managing data in a network according to claim 2 wherein said form-style window further includes means for listing fields of a table of said one of the platform data sources.

5. A method of managing data in a network according to claim 4 wherein said form-style window further includes means for selecting a number of said fields to be included in said derivative of the data source.

6. A method of managing data in a network according to claim 1 wherein said derivative of the data source is at least one table of a database.

7. A method of managing data in a network according to claim 1 wherein said derivative of the data source is a data file.

8. A method of managing data in a network according to claim 1 wherein the steps of accepting, processing and generating are carried out by an editor application.

9. A method of managing data in a network according to claim 1 wherein said administrator input includes access rights particulars for said one of the platform data sources.

10. Code employed in a network system, the system including at least one data access layer between at least one network data source and a common data access layer, the common data access layer providing a data access interface between services and the data source, the code comprising:
an editor application for creating an abstraction of said data source that coordinates at least one data service element in effectuating at least one operation on said data source, said data service element adapted to:
i. give at least one of said services defined access to said data source; and
ii. effectuate query-response communication between said at least one of the services and said data source through said data access layer, resulting in said operation and a data source response communicated to said at least one of the services in order for said at least one of the services to be performed.

11. Code according to claim 10 wherein said data service element includes a data source selector component.

12. Code according to claim 10 wherein said defined access includes at least a selected one of the following access rights: read, write, modify, create and delete.

13. Code according to claim 12 wherein said data source includes a database having tables and said access rights are associated with selected fields of said tables.

14. Code according to claim 10 wherein said editor application includes means for generating form-style windows.

15. Code according to claim 14 wherein said form-style windows include fields for displaying administrator input.

16. Code according to claim 15 wherein at least one of the form-style windows further includes a field filter configurer.

17. Code according to claim 10 wherein said data source includes a file on a file server.

18. Code according to claim 10 wherein said data access layer is a software module.

19. Code according to claim 18 wherein said software module is an OBDC drive.

20. Code according to claim 10 wherein said data access layer includes a translator for translating queries and responses of said query-response communication.
